(19) United States
(12) Patent Application Publication
(10) Pub. No.: US 2013/0056945 A1
(43) Pub. Date: Mar. 7, 2013

(54) BABY WALKER

(71) Applicant: Yi-Chen Huang, Chiayi County (TW)

(72) Inventor: Yi-Chen Huang, Chiayi County (TW)

(21) Appl. No.: 13/599,122

(22) Filed: Aug. 30, 2012

(30) Foreign Application Priority Data
Sep. 2, 2011 (TW) 100216469

(51) Int. Cl. B62B 7/04

(52) U.S. Cl. 280/87.051

(57) ABSTRACT

A baby walker includes a protective seat unit, a base ring unit, and a plurality of wheel units. The protective seat unit includes a bottom ring, at least one protective ring stacked above the bottom ring, and a seat connected to the protective ring. The bottom ring and the protective ring are inflatable. The base ring unit is detachably disposed under the bottom ring. The base ring unit includes a plurality of bottom rods removably connected to each other, and a plurality of fasteners fastening the bottom rods together. Each of the wheel units is attached to a bottom end of the base ring unit and includes a caster.

### CROSS-REFERENCE TO RELATED APPLICATION

This application claims priority of Taiwanese Application No. 100216469, filed on Sep. 2, 2011, the disclosure of which is incorporated herein by reference.

### BACKGROUND OF THE INVENTION

1. Field of the Invention

The invention relates to a baby walker, and more particularly to a baby walker having at least one inflatable protective ring.

2. Description of the Related Art

Referring to FIG. 1, a conventional baby walker 1 includes a base ring unit 11, two spaced-apart support units 12 respectively disposed on two opposite sides of the base ring unit 11, and a seat unit 13 disposed on and connected between the two support units 12. The base ring unit 11 has a hollow base ring 111 and a plurality of spaced-apart casters 112 disposed under the base ring 111 for moving on the ground. The seat unit 13 is elevated at a height above the ground by the support units 12. The seat unit 13 has a tray 131 with an opening, and a seat 132 suspended below the opening. The seat 132 is formed with a pair of spaced-apart openings 133 for a child (not shown) sitting on the seat 132 to extend his/her legs therethrough.

In use, the child is held and put in the conventional baby walker 1, the child's hip is supported on the seat 132 and the child's legs extend through the opening 133 so as to enable the child to propel the conventional baby walker 1 and to practice how to walk.

However, the conventional baby walker 1 has the following drawbacks:

1. Based on s non-separable connective structure of the base ring unit 11, the support units 12, and the seat unit 13, the conventional baby walker 1 is unable to be disassembled for reducing its size. The entire conventional baby walker 1 occupies relatively significant amount of space, thereby resulting in inconvenience during storage or transport.

2. The seat unit 13 is designed for the child to be seated alone, and the conventional baby walker 1 is not provided with any protection to guard the child. For the child in need of the baby walker, there is a great risk of being hurt in the environment. For example, the child may bump against protruding objects such as furniture, a corner of walls and so on. When practicing how to walk, the child may get injuries attributed to collision or impact with such protruding objects while using the conventional baby walker 1. Moreover, due to adults' carelessness or deficient protection design of the conventional baby walker 1, the child may come to serious harm as a result of accidental overturn when speedily sliding or moving to a stairway, or a bump on uneven ground.

### SUMMARY OF THE INVENTION

Therefore, an object of this invention is to provide a baby walker that can alleviate at least one of the aforesaid drawbacks of the prior art.

According to the present invention, a baby walker includes a protective seat unit, a base ring unit, and a plurality of wheel units. The protective seat unit includes a bottom ring, at least one protective ring stacked above the bottom ring, and a seat connected to the at least one protective ring. The bottom ring and the protective ring are inflatable rings. The base ring unit is detachably disposed under the bottom ring. The base ring unit includes a plurality of bottom rods removably connected to each other, and a plurality of fasteners fastening the bottom rods together. Each of the plurality of wheel units is attached to a bottom end of the base ring unit and includes a caster for moving on the ground.

### BRIEF DESCRIPTION OF THE DRAWINGS

Other features and advantages of the present invention will become apparent in the following detailed description of the embodiment with reference to the accompanying drawings, of which:

FIG. 1 is a perspective view showing a conventional baby walker;

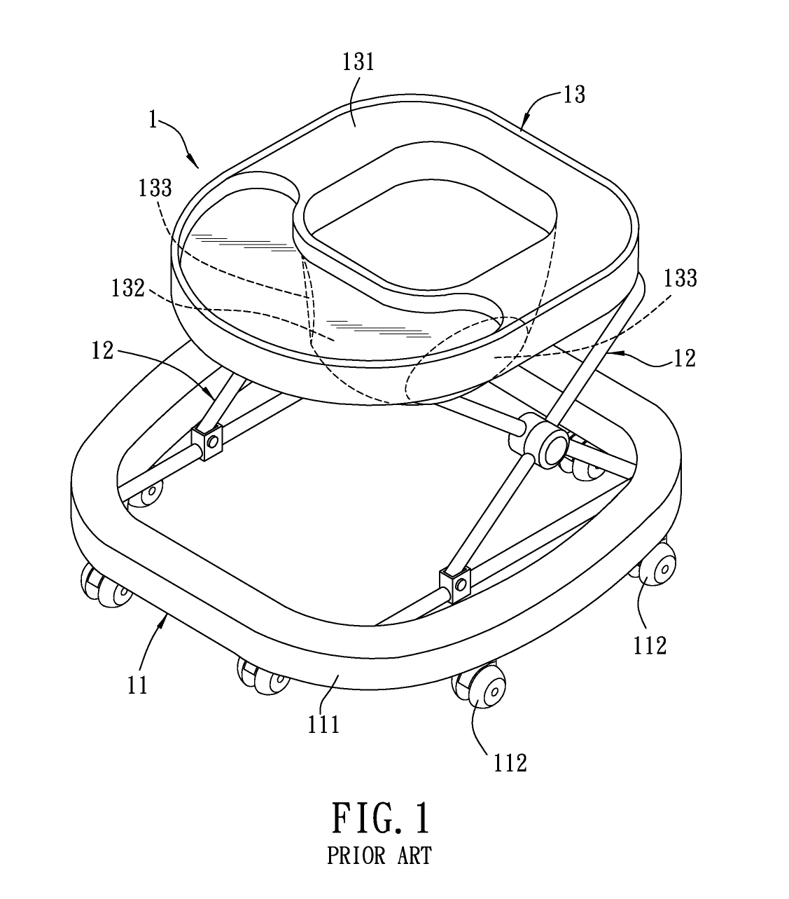

FIG. 2 is an exploded perspective view showing the preferred embodiment of a baby walker according to the present invention;

FIG. 3 is a sectional view showing the preferred embodiment of the baby walker in an assembled state;

FIG. 4 is a fragmentary exploded view showing structural engagements among a protective seat unit, a base ring unit and wheel units of the preferred embodiment of the baby walker;

FIG. 5 is a fragmentary, partly sectional view showing the structural engagements among the protective seat unit, the base ring unit and the wheel units of the preferred embodiment of the baby walker; and

FIG. 6 is a perspective view showing the preferred embodiment of the baby walker with a child seated therein.

### DETAILED DESCRIPTION OF THE PREFERRED EMBODIMENT

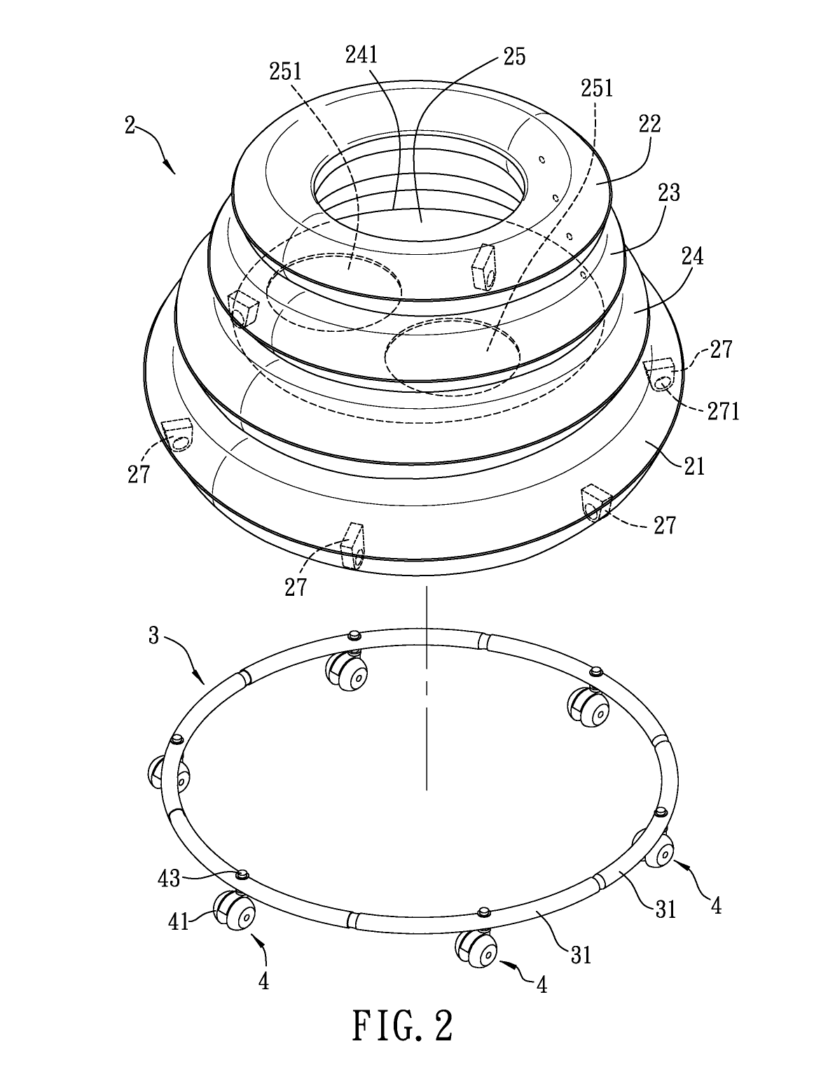

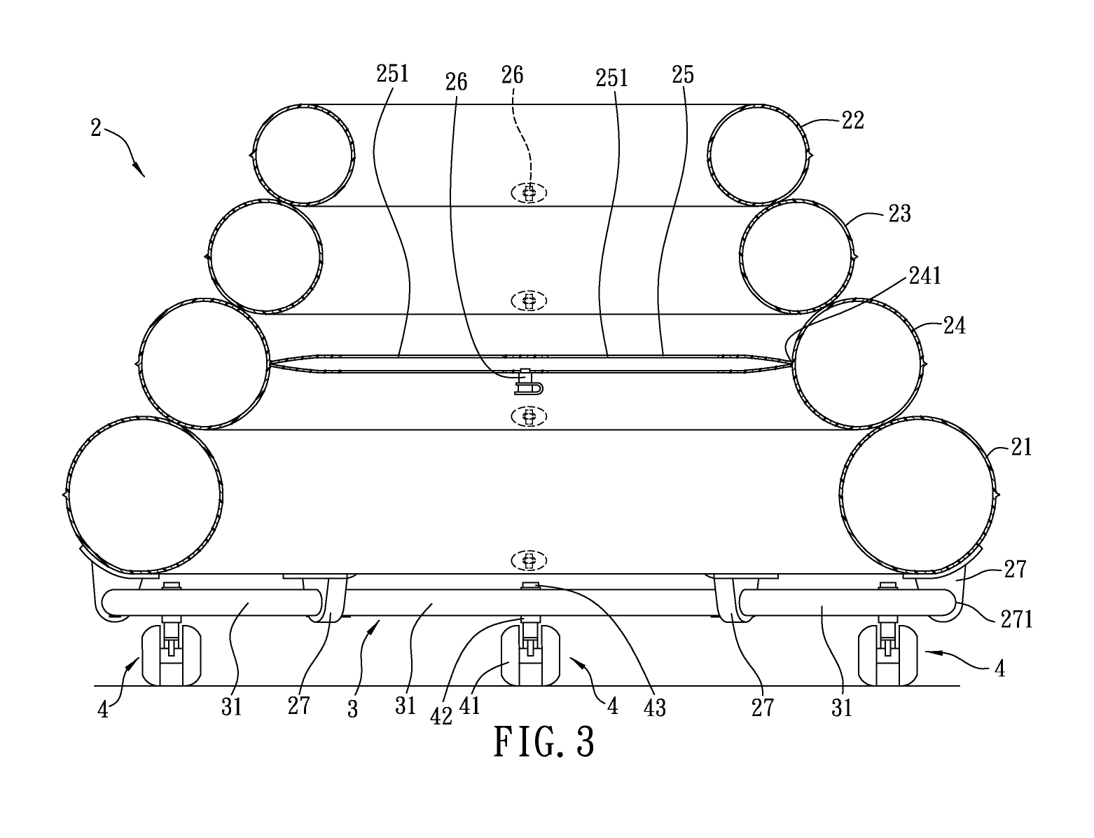

Referring to FIGS. 2 and 3, the preferred embodiment of a baby walker according to the present invention includes a protective seat unit 2, a bottom ring unit 3, and a plurality of wheel units 4.

The protective seat unit 2 includes a bottom ring 21, at least one protective ring stacked above the bottom ring 21, and a seat 25 connected to the at least one protective ring.

In this embodiment, the protective seat unit 2 includes first, second and third protective rings 22, 23, 24 stacked one on top of the other above the bottom ring 21. Moreover, the bottom ring 21 and the three protective rings 22, 23, 24 are inflatable rings and the seat 25 is an inflatable seat. The bottom ring 21, the protective rings 22, 23, 24 and the seat 25 may be made of an airtight and elastic material, such as rubber, plastics, and so on, and may be connected to each other using ultrasonic welding techniques. Preferably, the bottom ring 21 has an outer diameter greater than those of the first, second, and third protective rings 22, 23, 24. The outer diameters of the first, second, and third protective rings 22, 23, 24 are gradually enlarged from the first protective ring 22 to the third protective ring 24.

Preferably, the seat 25 is connected to an inner periphery 241 of the third protective ring 24 that is the lowest one of the three protective rings 22, 23, 24. In addition, the seat 25 includes a seat sheet spanning the inner periphery 241 of the third protective ring 24, and a pair of spaced-apart openings 251 formed in the seat sheet.

Preferably, the protective seat unit 2 includes a plurality of air nozzles 26 respectively disposed on the bottom ring 21, the three protective rings 22, 23, 24, and the seat 25 for controlling supply and discharge of air. Therefore, the bottom ring 21, the first, second, and third protective rings 22, 23, 24, and the seat 25 can be inflated to predetermined shapes or be folded or shrunk after being deflated. Since the structure of the nozzles 26 is well known to those of ordinary skill in the art, a detail description thereof will be omitted herein.

Preferably, the protective seat unit 2 further includes a plurality of spaced-apart collars 27 disposed under the bottom ring 21. Each of the collars 27 has a through hole 271.

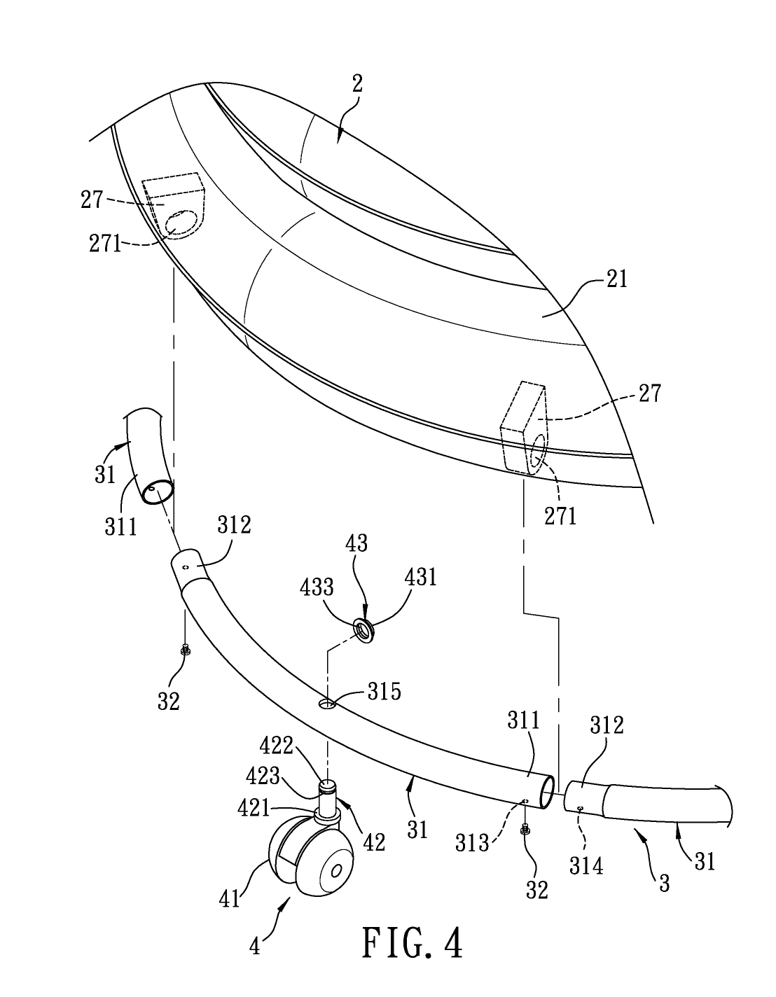

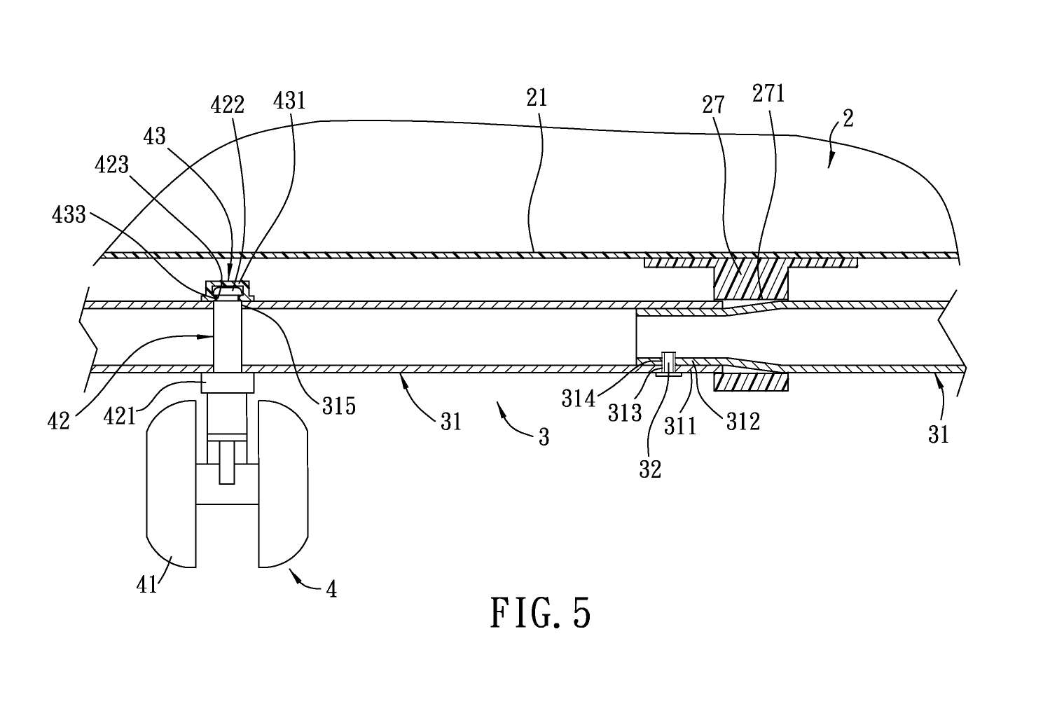

Referring FIGS. 3 to 5, a base ring unit 3 is detachably disposed under the bottom ring 21 and includes a plurality of bottom rods 31 removably connected to each other, and a plurality of fasteners 32 fastening the bottom rods 31 together.

Each of the bottom rods 31 is an arcuate tubular rod that is inserted through the through hole 271 of a corresponding one of the collars 27 and that has a hollow head portion 311 and an opposite constricted tail portion 312. The tail portion 312 of one of the bottom rods 31 is inserted into the head portion 311 of an adjacent one of the bottom rods 31. Preferably, the head portion 311 and the tail portion 312 of each of the bottom rods 31 has a first securing hole 313 and a second securing hole 314, respectively. The second securing hole 314 of the tail portion 312 of the one of the bottom rods 31 is aligned with the first securing hole 313 of the head portion 311 of the adjacent one of the bottom rods 31 when the tail portion 312 of the one of the bottom rods 31 is inserted into the head portion 311 of the adjacent one of the bottom rods 31. Preferably, each of the fasteners 32 is a screw that threadedly secures the first securing hole 313 of the head portion 311 of the adjacent one of the bottom rods 31 to the second securing hole 314 of the tail portion 312 of the one of the bottom rods 31. Each of the bottom rods 31 further has an insertion hole 315 extending therethrough in a top-bottom direction between the head and tail portions 311, 312.

In this embodiment, it should be noted that the number of the bottom rods 31 is equal to that of the collars 27, i.e., each of the bottom rods 31 is inserted through the corresponding one of the collars 27. However, in actual implementation, the number of the bottom rods 31 may be different from that of the collars 27. For example, the number of the bottom rods 31 may be greater than that of the collars 27, so that a pair of the bottom rods 31 that are connected together are inserted through one of the collars 27. Alternatively, the number of the bottom rods 31 may be smaller than that of the collars 27 so that one of the bottom rods 31 may be inserted through two of the collars 27.

Each of the wheel units 4 is attached to a bottom end of the base ring unit 3 and includes a caster 41 for moving on the ground, a shaft 42 extending upwardly from the caster 41 and being inserted into the insertion hole 315 of a corresponding one of the bottom rods 31, and a fixing member 43 retaining the shaft 42 in the insertion hole 315. Preferably, the shaft 42 has an annular abutment flange 421 protruding radially and outwardly and abutting against a bottom side of one of the bottom rods 31, and a top end portion 422 extending upward from the annular abutment flange 421 and extending through and out of the insertion hole 315. The top end portion 422 has an annular groove 423 proximate to a top side of the one of the bottom rods and indented radially and inwardly. In this embodiment, the fixing member 43 is made of a flexible plastic material and has a cap portion 431 that is sleeved around the top end portion 422 and that has an external diameter greater than that of the insertion hole 315. The cap portion 431 has an inner flange 433 engaging the annular groove 423.

During assembly, each of the wheel units 4 is first attached to the corresponding bottom rod 31 of the base ring unit 3, i.e., the caster 41 of each of the wheel units 4 is placed under the bottom side of the corresponding bottom rod 31, so that the shaft 42 extends upwardly through the insertion hole 315 of the corresponding bottom rod 31. The abutment flange 421 abuts against the bottom side of the corresponding bottom rod 31 and the top end portion 422 extends outwardly through the insertion hole 315 of the corresponding bottom rod 31. Then, the fastener 43 is put on and pressed against the top end portion 422, so that the cap portion 431 is outwardly expanded and sleeved around the top end portion 422 and so that the inner flange 433 engages the annular groove 423. Therefore, the wheel units 4 are assembled with the base ring unit 3.

Next, each of the bottoms rod 31 is inserted through the corresponding through hole 271, and the head portion 311 of each of the bottom rods 31 is connected to the tail portion 312 of the adjacent one of the bottom rods 31. The first securing holes 313 of the head portions 311 of the bottom rods 31 are in alignment with the second securing holes 314 of the tail portions 312 of the adjacent bottom rods 31 at this time. The fasteners 32 are threadedly extended through the first and second securing holes 313, 314, thereby securing the head portions 311 of the bottom rods 31 to the tail portions 312 of the adjacent bottom rods 31. Therefore, the bottom ring unit 3 is assembled with the protective seat unit 2, and the casters 41 of the wheel units 4 are able to be placed in contact with the ground for rolling and moving.

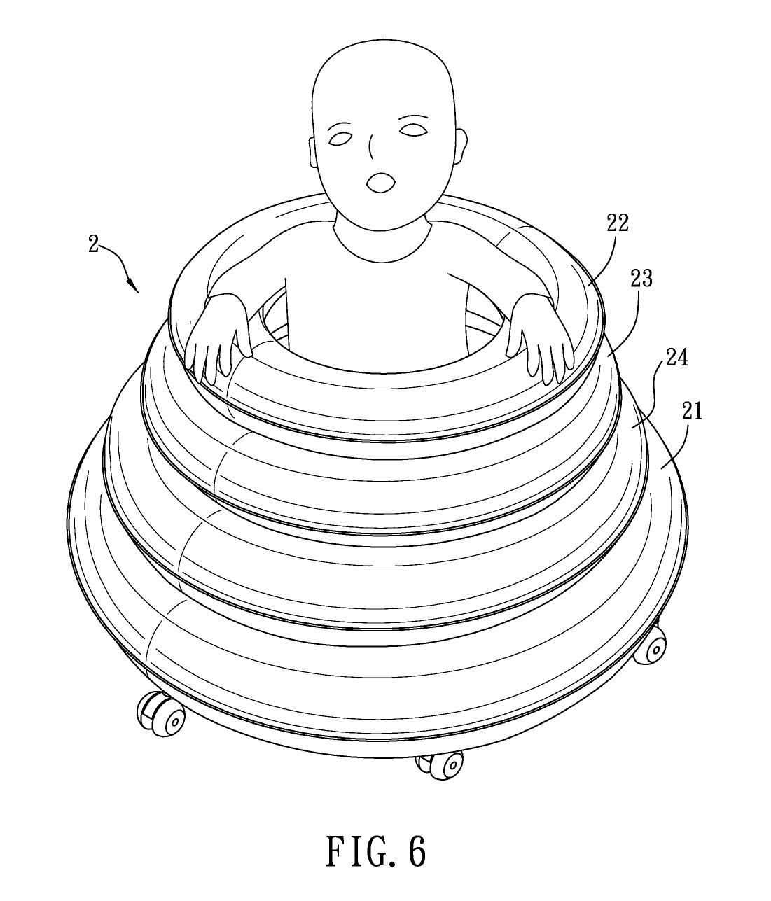

Referring to FIGS. 2, 3, and 6, through utilization of an inflation device or a human mouth (not shown), the air nozzles 26 control supply of air for inflating the bottom ring 21, the first, second, and third protective rings 22, 23, 24, and the seat 25 to have the predetermined shapes, respectively. After, closing the nozzles 26, the protective seat unit 2 is in an inflated state, which permits seating of a child therein.

In use, the child is held and put in the protective seat unit 2 for extending the child's legs through the openings 251 and for sitting the child in the seat 25, so that the first, second, and third protective rings 22, 23, 24 can surround the child and so that the child's legs can touch the ground between standing and sitting positions for practicing how to walk.

When the baby walker of the present invention is to be stored or carried, the fasteners 32 are detached from the bottom rods 31 for disassembling the base ring unit 3. The bottom rods 31 are subsequently removed from the collars 27, so that the base ring unit 3 is taken off the protective seat unit 2. The fixing members 43 are pulled away from the shafts 42, and the shafts 42 are disconnected from the bottom rods 31 so as to disassemble the wheel units 4 and the base ring unit 3. Finally, the air nozzles 26 are opened and air is discharged therefrom by pressing the bottom ring 21, the three protective rings 22, 23, 24, and the seat 25, so that the seat unit 2 can be flat and folded for storage, i.e., the baby walker of the present invention is easily disassembled and foldable for storage in a relatively small space.

To sum up, the baby walker of the present invention provides the following advantages:
1. According to the present invention, the protective seat unit 2 is designed to be inflatable. The bottom ring unit 3 is detachable to be disposed under the protective seat unit 2, and the wheel units 4 are removably attached under the bottom ring unit 3. Therefore, when not in use, the bottom ring unit 3 is detached from the protective seat unit 2, and the wheel units 4 are removed from the bottom ring unit 3. Subsequently, air is discharged from the protective seat unit 2 so that the protective seat unit 2 is folded and shrunk. Therefore, the baby walker of the present invention can have a relatively smaller size to facilitate storage and transport.
   2. Based on the design, the protective seat unit 2 is inflatable and resilient. The three protective rings 22, 23, 24, and the bottom ring 21 are gradually enlarged from the first protective ring 22 to the bottom ring 21. In use, the child is surrounded in the protective seat unit 2. When the baby walker collides with furniture, walls, or other sharp objects, the first, second, and third protective rings 22, 23, 24, and the bottom ring 21 can buffer such collision to protect the child. Moreover, when the child in the baby walker speedily slides or moves to a stairway, or a bump on uneven ground, the baby walker of the present invention may reduce the risk of overturning. By virtue of protection provided by the protective seat unit 2, the protective seat unit 2 can reduce or alleviate the risk of accidental injuries, thereby effectively achieving child protection.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A baby walker comprising:
a protective seat unit including a bottom ring, at least one protective ring stacked above said bottom ring, and a seat connected to said at least one protective ring, said bottom ring and said protective ring being inflatable rings;
a base ring unit detachably disposed under said bottom ring, said base ring unit including a plurality of bottom rods removably connected to each other, and a plurality of fasteners fastening said bottom rods together; and
a plurality of wheel units each attached to a bottom end of said base ring unit and including a caster for moving on the ground.

2. The baby walker as claimed in claim 1, wherein said seat is connected to an inner periphery of said protective ring.

3. The baby walker as claimed in claim 1, wherein said protective seat unit further includes a plurality of spaced-apart collars disposed under said bottom ring, each of said collars having a through hole, through which one of said bottom rods of said base ring unit is inserted.

4. The baby walker as claimed in claim 1, wherein said seat includes a seat sheet spanning said inner periphery of said protective ring, and a pair of spaced-apart openings formed in said seat sheet.

5. The baby walker as claimed in claim 1, wherein said protective seat unit includes first, second and third protective rings stacked one on top of the other above said bottom ring, said bottom ring being greater in outer diameter than said first, second, and third protective rings, the outer diameters of said first, second, and third protective rings being gradually enlarged from said first protective ring to said third protective ring.

6. The baby walker as claimed in claim 5, wherein said seat is connected to a lowest one of said first, second and third protective rings.

7. The baby walker as claimed in claim 1, wherein each of said bottom rods has a hollow head portion and an opposite constricted tail portion, said tail portion of one of said bottom rods being inserted into said head portion of an adjacent one of said bottom rods, each of said fasteners being a screw that threadedly secures said head portion of the adjacent one of said bottom rods to said tail portion of the one of said bottom rods.

8. The baby walker as claimed in claim 1, wherein each of said bottom rods has an insertion hole 315 extending therethrough in a top-bottom direction, each of said wheel units further including a shaft extending upwardly from said caster and inserted into said insertion hole, and a fixing member retaining said shaft in said insertion hole.

9. The baby walker as claimed in claim 8, wherein said shaft has an annular abutment flange protruding radially and outwardly and abutting against a bottom side of one of said bottom rods, and a top end portion extending upward from said annular abutment flange and extending through and out of said insertion hole, said top end portion having an annular groove proximate to a top side of said one of said bottom rods and indented radially and inwardly, said fixing member having a cap portion that is sleeved around said top end portion and that has an external diameter greater than that of said insertion hole, said cap portion having an inner flange engaging said annular groove.

10. The baby walker as claimed in claim 1, wherein said protective seat unit further includes a plurality of air nozzles respectively disposed on said bottom ring and said protective ring for controlling supply and discharge of air.

11. The baby walker as claimed in claim 1, wherein said seat is an inflatable seat, said protective seat unit further including an air nozzle disposed on said seat for controlling supply and discharge of air.
